(19) United States
(12) Patent Application Publication
(10) Pub. No.: US 2013/0330579 A1
(43) Pub. Date: Dec. 12, 2013

(54) BATTERY BLOCK AND POWER SUPPLY DEVICE

(71) Applicants: Yuki Ejiri, Hitachinaka (JP); Naoki Kojima, Hitachinaka (JP); Michihiro Kimura, Hitachi (JP)

(72) Inventors: Yuki Ejiri, Hitachinaka (JP); Naoki Kojima, Hitachinaka (JP); Michihiro Kimura, Hitachi (JP)

(73) Assignee: Hitachi Vehicle Energy, Ltd., Hitachinaka-shi, Ibaraki (JP)

(21) Appl. No.: 14/000,830

(22) PCT Filed: Mar. 25, 2011
(86) PCT No.: PCT/JP2011/057339

§ 371 Date: Aug. 21, 2013

(51) Int. Cl. H01M 2/12; H01M 2/34

(52) U.S. Cl. CPC H01M 2/12; H01M 2/34
USPC 429/53

(57) ABSTRACT

In a battery block, a plurality of battery cells are arrayed, connected, and fixed, and the plurality of battery cells are separated into a plurality of sections, each of which includes a predetermined number of battery cells separated as one section by a section plate. The battery block is sandwiched between two end plates and the two end plates and the section plates are bolted down and fixed via a plurality of rods extending along a direction in which the battery cells are arrayed. The battery cells each include a gas vent valve, and the battery block includes a vent duct that establishes communication between the gas vent valves of the battery cells.

### TECHNICAL FIELD

The present invention relates generally to battery blocks each including a plurality of arrayed, connected, and fixed battery cells. More particularly, the invention is directed to a battery block capable of being reduced in dimensions and weight and equipped with a vent duct that releases a gas from a hermetically enclosed prismatic case when a constant internal gas pressure is reached. The invention is further directed to a power supply device that uses the battery block.

### BACKGROUND ART

A conventional battery pack formed by arraying and fixing a number of battery cells, as disclosed in Patent Document 1, for example, includes separators connected to the battery cells in alternately arranged form with end faces of each battery cell insulated with end plates. Each end plate is formed into a size convenient for insulating the corresponding battery cell exposed at one end face, and two end plates are placed at both end faces of one battery cell to hold and fix it from both sides. In the particular conventional example, one pair of screw holes protruded on a side face of each end plate are provided and extension bolts extending along side faces of the battery pack formed by stacking the battery cells are passed through to the end plates to threadedly fix the end plates.

In another conventional battery pack, as disclosed in Patent Document 2, for example, a plurality of unit cells each provided with a safety valve to release a gas when a constant internal gas pressure is reached are arranged in parallel. The battery pack described in Patent Document 2 includes a gas vent device fitted with a vent port of the safety valve of each unit cell connected to one or a plurality of exhaust gas, tubes extending in a direction that the unit cell is disposed. One end of each of the exhaust gas tubes is connected to an external vent tube, the external vent tube being mounted on a fixing member via a support fixture so as to be shiftable in position in the direction that the unit cell is disposed.

Furthermore, a power supply device is disclosed including a cell assembly provided with a plurality of cells each having a positive electrode and a negative electrode, and measuring means for measuring a difference in potential between the positive electrode and negative electrode of each cell constituting the cell assembly. The measuring unit includes a main body of the measuring unit, and a flexible printed circuit (FPC) section as a flat circuit structure, the FPC section being bolted down onto outer peripheries of the positive and negative electrodes via nuts and the like to fix the cells, the measuring unit main body, the FPC section, and bus bars.

### PRIOR ART LITERATURE

### Patent Documents

Patent Document 1: JP-2008-186725-A
Patent Document 2: Japanese Patent No. 4370027
Patent Document 3: Japanese Patent No. 4001730

### SUMMARY OF THE INVENTION

### Problems to be Solved by the Invention

The battery pack described in Patent Document 1 has had a problem in that if too many battery cells are arrayed adjacently to one another, length of the extension bolts for fixing each battery cell interposed between the end plates will increase and thus the battery cells are likely to easily move and shift in position. The battery pack described in Patent Document 2 is constructed so that at a lower portion of each exhaust gas tube that exists at a position corresponding to the vent port of each safety valve, vent port connections each having a shape substantially rectangular in plan view are provided in a downward protruded condition and an expandable bellows portion is formed between the vent port connections in order to accommodate changes in spacing between the vent ports of the safety valves due to expansion of the unit cells. The battery pack according to Patent Document 2, however, has had a problem in that gas leakage is liable to occur between the vent ports and the vent port connections. The power supply device described in Patent Document 3 has had a problem in that since the FPC section is placed on an upper portion of the cell assembly and screwed down onto each positive electrode and negative electrode via the nuts, adding an exhaust passageway and the like to discharge the gas released from the cell case will increase length of the FPC section to upscale the entire device too much in volume.

The present invention has been made with these problems in mind, and an object of the invention is to provide a battery block that is free from a disturbance in an array of a plurality of battery cells due to a probable shift in position of the battery cells, excels in shape stability, and constructed to implement compactness and weight reduction. The present invention is also intended to provide a battery block formed to release an exhaust gas from a case of battery cells efficiently and to allow a thin-walled circuit board to be mounted to measure a voltage of the battery cells. In addition, the present invention is intended to provide a power supply device that can use the above battery block to achieve a compact, lightweight device structure.

### Means for Solving the Problems

In order to attain the above object, a battery block according to the present invention includes a plurality of arrayed, connected, and fixed battery cells, the battery cells being constituted by a plurality of sections with a predetermined number of battery cells separated as one section by a section plate. In addition, the battery block is sandwiched between two end plates, and the two end plates and the section plates are bolted/screwed down and fixed via a plurality of rods extending through the end plates and the section plates, along a direction in which the battery cells are arrayed. The battery cells each include a gas vent valve, and the battery block includes a vent duct that establishes communication between the gas vent valves of the battery cells.

The above-constructed battery block of the present invention, having the plurality of arrayed, connected, and fixed battery cells, is formed to allow the predetermined number of battery cells to be separated as one section by a section plate. This construction, compared with a construction in which only end plates at both ends of a battery block or pack are used to hold a number of battery cells from both sides and a plurality of rods are used to bolt/screw down and fix the battery cells, prevents the battery cells from moving away from one another, stabilizes a connection state of the battery block, and improves shape stability. In addition, all gas from the gas vent valves of the battery cells can be released at the same time from the vent valves through the vent duct.

A power supply device according to another aspect of the present invention includes the above battery block formed in two vertical layers and accommodated in a box, the box including a lower case, an upper case, and a partition plate positioned midway between the cases. The battery block of the lower layer is accommodated in the lower case, the partition plate intervenes between the battery block of the lower layer and the battery block of the upper layer, the battery block of the upper layer is fixed to the partition plate and accommodated in the upper case, and the lower case, the separation plate, and the upper case are connected together and fixed at an outer peripheral edge, an outer peripheral region, and an outer peripheral edge, respectively, thereof. In this construction, the box is formed by the three stacked members, the battery block of the lower layer is fixed to an upper surface of the lower case, the battery block of the upper layer is fixed to an upper surface of the partition plate, and the battery block of the upper layer is overlaid with the upper case. This reduces the number of parts required and hence, that of working hours required for assembly.

### Effects of the Invention

The battery block of the present invention prevents the plurality of arrayed battery cells from shifting in position and thus the array from becoming disturbed, so that the battery block enhances the stability of its shape and improves quality. The battery block is also effective for releasing an exhaust gas from a case of the battery cells efficiently and for sensing a state of the battery cells. Additionally, the number of battery cells between the section plates can be changed to respond to requirements relating to voltage, capacity, and the like. Furthermore, rapid processing of improper or inappropriate electrical interconnects and other trouble can be implemented by providing a fuse on the circuit board.

### BRIEF DESCRIPTION OF THE DRAWINGS

FIG. 1 is a perspective view showing in partially omitted form an embodiment of a battery block according to the present invention.

FIG. 2 is a perspective view showing one part of FIG. 1 in a developed state.

FIG. 3 is a perspective view of a battery holder shown in FIGS. 1 and 2.

FIG. 4 is a perspective view that shows as-developed essential elements of the battery block according to the present invention.

FIG. 5 is a perspective view that is a partially developed view of a voltage sensing board and a vent duct, both shown in FIG. 1.

FIG. 6 is a perspective cutaway view representing a relationship between a vent duct and a gas vent valve of a battery cell.

FIG. 7 is a perspective view of a major region, showing a vent duct connection.

FIG. 8 is a sectional view of a major region, taken along line D-D of FIG. 7.

FIG. 9 is a perspective view showing an embodiment of a power supply device using the battery block according to the present invention.

FIG. 10 is a perspective view showing the power supply device of FIG. 9 in a disassembled condition.

### MODES FOR CARRYING OUT THE INVENTION

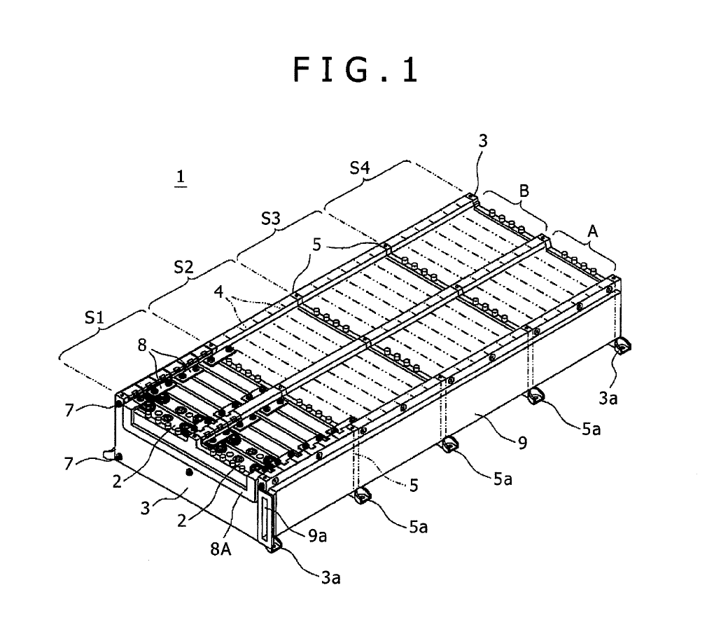

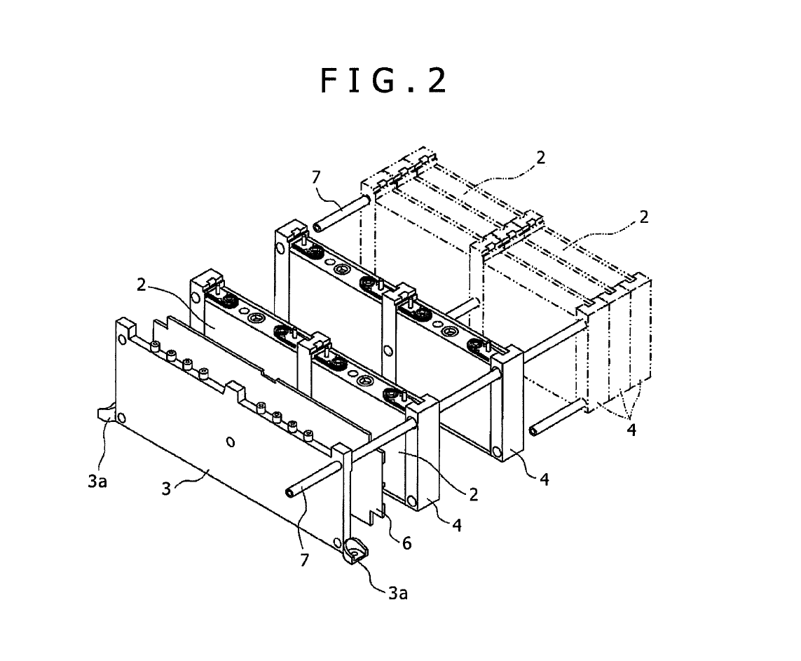

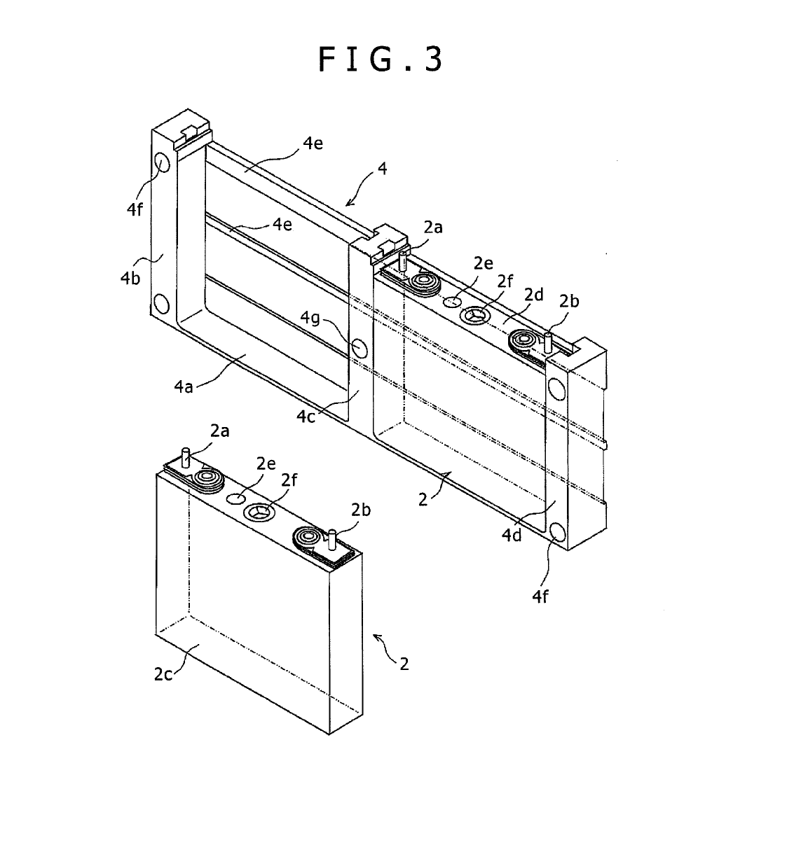

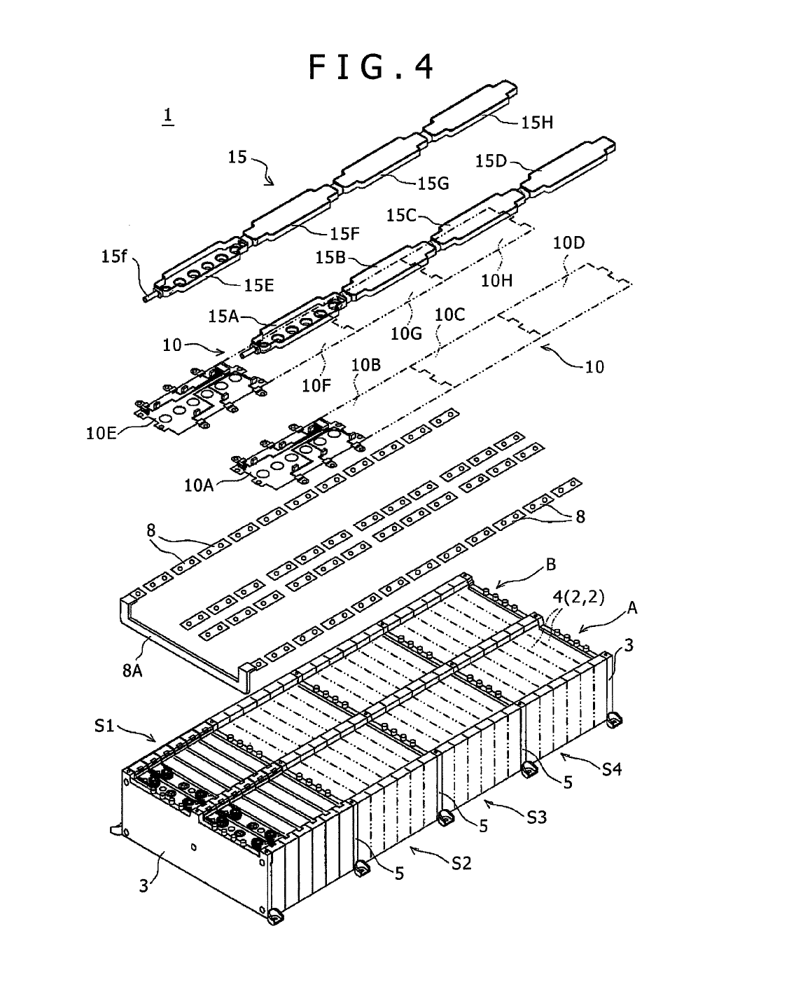

Hereunder, a battery block and a power supply device according to the present invention will be described in detail in accordance with the accompanying drawings. FIG. 1 is a perspective view of the battery block according to the present embodiment, with one part of arrayed battery holders being omitted in the perspective view. FIG. 2 is a perspective view showing one part of the battery block of FIG. 1 in a developed state, and FIG. 3 is a perspective view showing a battery holder for holding two battery cells, with one of the two battery cells being separately shown. FIG. 4 is a perspective view that shows as-developed constituent elements of the battery block.

Referring to FIGS. 1 to 4, the battery block 1 according to the present embodiment includes a plurality of arrayed, connected, and fixed battery cells 2, 2 . . . and is sandwiched between two end plates 3, 3. In the present embodiment, two battery holders 2, 2, are arranged in a plane direction of one battery holder 4, and a total of twenty-four battery holders 4, 4 . . . , are arrayed in a direction orthogonal to the plane direction. Section plates 5, 5 . . . are interposed every six battery holders 4, the two end plates and three section plates form four sections, S1 to S4, and the end plates 3, 3 and the section plates 5, 5 intervene every six battery holders 4. In addition, an electrical-insulating cell spacer 6 formed from a resin thin plate intervenes between one end plate 3 and one battery holder 4 adjacent thereto. In a horizontal direction on a surface of the cell spacer 6 that faces the battery holder 4 is formed a transverse groove, along which air is blasted to cool side faces of the battery cells 2, 2 held by the battery holder 4.

The end plates 3, 3 have a function of partition plates arrayed to intervene between a plurality of battery cells 2. In other words, the battery block 1 includes five partition plates, 3, 5, 5, 5, 3, that constitute the four sections, S1 to S4, each of which includes six battery holders 4. One end plate 3 and one partition plate 5 are both formed from a resin or the like and constructed to have the same shape. The end plate 3 and the partition plate 5 have a foot 3a, 3a and foot 5a, 5a, respectively, protruded downward at both ends of each to fix the battery block 1, the feet each being formed with a through-hole through which to insert a locking bolt.

That is to say, the battery block 1 has the construction with a cell spacer 6 disposed adjacently to one end plate 3, six rows of battery holders 4, each row including two battery cells 2, 2 lined up adjacently to the cell spacer 6, six more rows of battery holders 4 arranged after placement of a first section plate 5, six additional rows of battery holders 4 arranged after placement of a second section plate 5, and six further rows of battery holders 4 arranged after placement of a third section plate 5. The arrangement of the last six rows of battery holders 4 is followed by mounting of the other end plate 3. In the battery block 1, therefore, six rows of battery holders 4, each row having a bank of two battery cells 2, form one section, and three more sections are formed to construct four sections for an arrangement of 48 battery cells 2 in all.

The battery cells 2 are all lithium-ion secondary cells of the same configuration and, although not described in detail, each battery cell 2 includes a positive electrode constructed from a positive electrode metal foil, which is made of aluminum or the like, and from a positive electrode mixture layer obtained by coating an upper surface and lower surface of the positive electrode metal foil with a positive electrode materials mixture. The battery cell 2 also includes a negative electrode constructed from a negative electrode metal foil made of a thin metal film material such as copper, and from a negative electrode mixture layer obtained by coating an upper surface and lower surface of the negative electrode metal foil with a negative electrode materials mixture. The positive electrode and the negative electrode are wound in flat form around a resin-made plate-like core with a porous and electrical-insulating separator interposed between both electrodes, thereby to construct a group of electrodes.

A positive electrode tab protruding from the positive electrode is connected to a positive electrode current-collecting plate by ultrasonic welding, and the positive electrode current-collecting plate with the positive electrode tab connected thereto is connected to a positive electrode outside terminal 2a. Similarly, negative electrode tab protruding from the negative electrode is connected to a negative electrode current-collecting plate by ultrasonic welding, and the negative electrode current-collecting plate with the negative electrode tab connected thereto is connected to a negative electrode outside terminal 2b. Both outside terminals 2a, 2b are formed into a bolt-like shape and constructed to allow the connecting terminal to be fixed using a nut. The electrode group including the positive electrode outside terminal 2a and the negative electrode outside terminal 2b is accommodated in a flat prismatic case 2c, and this case is sealed atop with a battery cover 2d. A filling port 2e is formed on the battery cover 2d, and the case 2c is filled with a nonaqueous electrolyte solution from the filling port.

The thus-constructed battery cell 2 might be exposed to a high-temperature environment or encounter internal short-circuiting caused by deterioration of the electrodes or the separator, by external short-circuiting, or by a change in shape of the battery, or suffer a sudden temperature rise caused by forcible overcurrent charging from an external power supply, or by overcharging on an excessive voltage. In such a case, the electrolyte may become dissolved or vaporized to generate a gas, and if this happens, the gas will fill the battery interior and the battery will increase in internal pressure. For this reason, a gas vent valve 2f that will release the internal gas from the prismatic case when the internal pressure thereof increases above a predetermined level is formed on the battery cover 2d. The gas vent valve 2f is sealed with a thin-film resin, having a thin-walled portion formed in three directions so as to easily rupture if the internal pressure rises to the predetermined level. In this way, one battery cell 2 blocks an upper opening of the prismatic case 2c with the battery cover 2d, and the battery cover 2d includes the bolt-like positive electrode outside terminal 2a and negative electrode outside terminal 2b, the battery cover 2d further including the filling port 2e and the gas vent valve 2f, both formed centrally on the battery cover 2d.

Each battery holder 4 in which two battery cells 2 are arranged sideways is formed from a plastic material or the like and has three pillars 4b, 4c, 4d standing upright from a base plate 4a, and one side face of each of the three pillars connected by cross bars 4e, and one battery cell 2 is inserted and held in a space defined by upper and lateral openings constructed by the three pillars 4b, 4c, 4d, the base plate 4a, and the cross bars 4e. Five through-holes through which five connecting rods are to be inserted for integrated arrayal of the battery holders 4, 4 . . . in rows are formed on surfaces of the three pillars. More specifically, four through-holes 4f, 4f, two on the surface of each of the left and right pillars 4b and 4d, respectively, are formed and one through-hole 4g is formed on the surface of the central pillar 4c.

The cross bars 4e, 4e that connect one side face of each of the three pillars 4b, 4c, 4d protrude from the pillars and are constructed so that when the battery holder 4 adjacent to the cross bars comes into contact, a space is formed in a horizontal direction to allow cooling of the battery cells 2 by moving air through the space. This air-blasting space using the cross bars 4e, 4e of the battery holder 4 has the same function as that of the transverse groove formed on the surface of the cell spacer 6. In addition, on the end plates 3, 3 disposed at both ends of the battery block 1, five through-holes are formed at the same positions as those of the five through-holes, 4f, 4f, 4g . . . , formed in each battery holder 4. Furthermore, on each section plate 5, five through-holes are formed at the same positions as those of the five through-holes, 4f, 4f, 4g . . . , described above. The connecting rods 7 are constructed so as to be able to extend through the end plates 3, 3, the section plates, 5, 5 . . . , and the battery holders 4, 4 . . . , and to connect together and fix these elements. While in the cell spacer 6 only a central through-hole is formed and positions corresponding to the other four through-holes in each battery holder 4 are notched, the cell spacer 6 may have five through-holes at the same positions as the above.

The integration of the battery cells in the battery block 1, in which each battery holder 4 containing two battery cells, 2, 2, arranged in parallel, is connected in series in rows consisting of 24 battery holders in all, is achieved by fastening and connecting the end plates 3, 3 together from both ends of the battery block 1 by means of the five connecting rods 7. In other words, the five connecting rods, 7, 7 . . . , are passed through the five through-holes in the end plates 3, 3, the notches and one through-hole in the cell spacer 6, the four upper and lower through-holes 4f, 4f . . . formed on the surfaces of the left and right pillars of each battery holder 4, one through-hole 4g formed centrally on the surface of the central pillar, and the five through-holes in each of the three section plates 5. After that, locking bolts are inserted into male screw holes formed at both ends of each connecting rod, and the locking bolts are tightened, whereby the battery cells can be integrated as the battery block 1.

In the battery block 1, adjacent battery cells are disposed so that the respective positive electrode outside terminals 2a and the negative electrode outside terminals 2b are positioned at opposite sides alternately. In this layout manner, the outside terminals adjacent to each other in a direction of their thickness serve as a positive electrode and a negative electrode, and connecting the positive electrode and the negative electrode together using rectangular short bus bars (connecting bars) 8, 8 . . . allows the adjacent battery cells 2, 2 to be connected in series. A voltage that 48 battery cells 2, 2 . . . connected in series generate can be extracted from the outside terminals at right ends of battery cell arrays A and B. This can be achieved by connecting in series the 24 battery cells of the four sections in array A via bus bars 8, 8 . . . , further connecting the positive electrode (negative electrode) of the battery cell 2 at a left end of array A and the negative electrode (positive electrode) of the battery cell 2 at a left end of array B via a long outside bus bar 8A, and moreover connecting the 24, battery cells 2 of array B via the short bus bars 8.

On a side face of the battery block 1, an air duct 9 through which the cooling air is to be blasted is mounted in a lengthwise direction of the battery block 1, that is, along an axis of each connecting rod 7. The air duct 9 located to the front of the battery cell group has a blasting port 9a at one end side of the battery block 1, and an air-discharging duct (not shown) at a rear side of the battery cell group has an discharge port (not shown) at the other end side of the battery block 1. The air from the air duct 9 flows through the clearances between the cross bars 4e, 4e of the battery holder 4 and along the transverse groove in the cell spacer 6, next passes along the side faces of the two battery cells 2, 2 arranged sideways, and while cooling the battery cells, reaches the discharging duct, from which the air is then discharged. The large number of battery cells 2 can be cooled efficiently by supplying the air from the air duct 9 mounted along one side face of the battery block 1 with the plurality of arrayed, connected, and fixed battery cells, propagating the cooling air along the clearances formed between the cross bars, as well as the transverse grooves formed between the plurality of battery holders 4, 4 . . . , and discharging the air from the air duct mounted along the other side face. Although one air duct only is shown, the other air duct has a left/right-inversed shape relative to that of the air duct 9 shown in the drawing, and the air that has entered from the blasting port 9a at the left side of the air duct 9 in front exits from the right side of the air duct at rear.

A voltage sensing board (hereinafter, referred to as the printed circuit board) 10 that constitutes a sensing unit for sensing the voltage obtained from the large number of battery cells 2, 2 . . . is mounted at an upper section of the battery block 1. This printed circuit board may be constructed as one large circuit board that shrouds upper regions of all battery cells 2, but in the present embodiment, the circuit board is constructed from eight boards divided into two rows for one section. That is to say, one section includes 12 battery cells 2 formed by six battery holders 4 each having two battery cells arranged in two arrays, and one printed circuit board 10A is placed at an upper section of the six battery cells 2 in array A, and the other printed circuit board 10B is placed at an upper section of the six battery cells 2 in array B.

A voltage of the six battery cells in one section S1 is measured with the printed circuit board 10A placed at the upper section of the six battery cells 2 in array A, and a voltage of the six battery cells in another section is measured with the printed circuit board 10B placed at the upper section of the six battery cells 2 in array B. Similarly to the above, two printed circuit boards, 10C and 10D, are arranged on a second section S2, two printed circuit boards, 10E and 10F, on a third section S3, and two printed circuit boards, 10G and 10H, on a fourth section S4. Briefly, eight printed circuit boards 10 in all are arranged on the four sections.

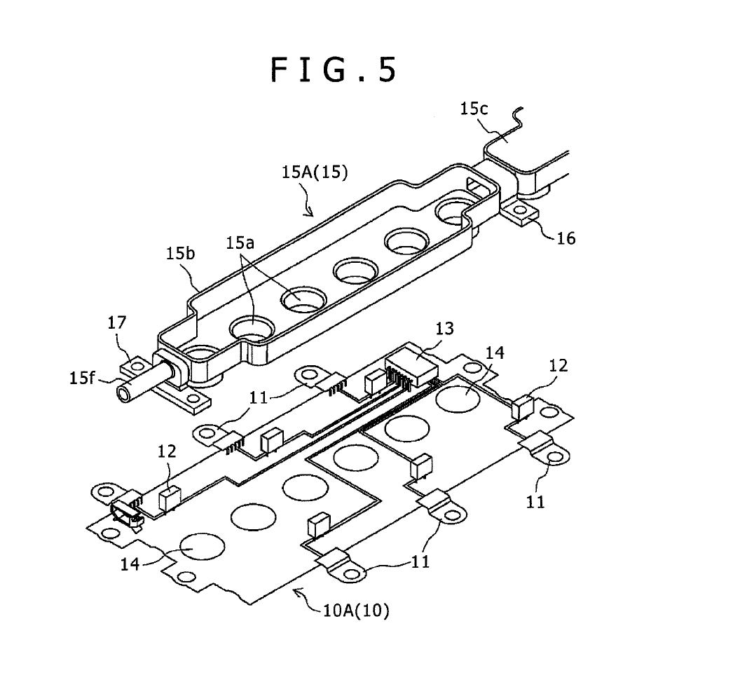

One printed circuit board 10A is described in detail below referring to FIG. 5. The printed circuit board 10A constitutes the measuring unit for measuring the voltage of six battery cells 2, 2 . . . , and six connecting terminals, 11, 11 . . . , provided for connection to the outside terminals 2a, 2b of the battery cells 2, are fixed in a state protruded from both side faces of the board. Through-holes through which the bolts of the outside terminals 2a, 2b are to be inserted are formed in the connecting terminals 11, and inserting the bolts of the outside terminals into the through-holes and then tightening nuts allows the printed circuit board to be fixed and to be connected to the terminals. In addition, concavities and convexities are formed at alternate positions on a short lateral side of the printed circuit board 10 to enable connection of adjacent boards. The boards 10 can be immobilized by bolting down each board onto pillars formed at top of the end plates 3 and section plates 5, after inserting the locking bolts into through-holes formed at the concavities and the convexities.

On each of the printed circuit boards 10A to 10H, immobilized fuses 12 are fixed and an immobilized connector 13 for connection to a wire harness is also fixed, and the fuses and the connector are connected together through interconnects. Six through-holes 14 are formed in line centrally on each board that constitutes the printed circuit boards 10A to 10H. The through-holes 14 have an appropriate shape so that vertical pipe parts 15a, which are communicating parts of a vent duct 15 (described below) that communicate with the gas vent valves 2f, 2f . . . of the battery cells 2, 2 . . . , can be passed through the through-holes 14.

As shown in FIGS. 4, 5, the vent duct 15 communicating with the gas vent valve 2f of each battery cell 2 is placed at an upper region of the corresponding printed circuit board 10A to 10H. The vent duct 15 is divided for each section, in both arrays A and B of the battery block 1, and includes a total of eight duct materials, 15A to 15D and 15E to 15H. Four of the eight duct materials are connected together to form a vent duct 15 of array A, and the remaining four duct materials are connected together to form a vent duct 15 of array B. Each duct material basically includes a top-opened main body 15b that has centrally the six vertical pipe parts 15a communicating with the gas vent valve 2f of each battery cell 2, and a cover 15c that covers the top-opened region of the main body 15b. The duct materials can be connected to each other by connecting an opening 15d formed at one end of the duct, and an opening 15e formed at the other end. A vent pipe 15f is connected to the opening at one end of each of the duct materials 15A, 15E positioned at a left end side in FIG. 4, and the opening at the other end of each of the duct materials 15D, 15H positioned at a right end side is blocked.

In the thus-constructed vent duct 15, the gas vent valves 2f of the six battery cells 2 in the first section S1 of array A communicate with a first duct material 15A, and the gas vent valves 2f of the six battery cells 2 in the second section S2 of array A communicate with a second duct material 15B. Likewise, the gas vent valves 2f in the third section S3 communicate with a third duct material 15C, and the gas vent valves 2f in the fourth section S4 communicate with a fourth duct material 15D. The fourth duct material 15D is closed at the right end thereof, and the gas is released from the vent pipe 15f fixed to the opening at the left end of the first duct material 15A. Similarly to the duct materials in array A, a first duct material 15E to fourth duct material 15H in array B are constructed so that the gas vent valves 2f of the battery cells 2 in the sections S1 to S4 communicate with the duct materials in the respective sections, the fourth duct material 15H is closed at the right end thereof, and the gas is released from the vent pipe 15f fixed to the opening at the left end of the first duct material 15E.

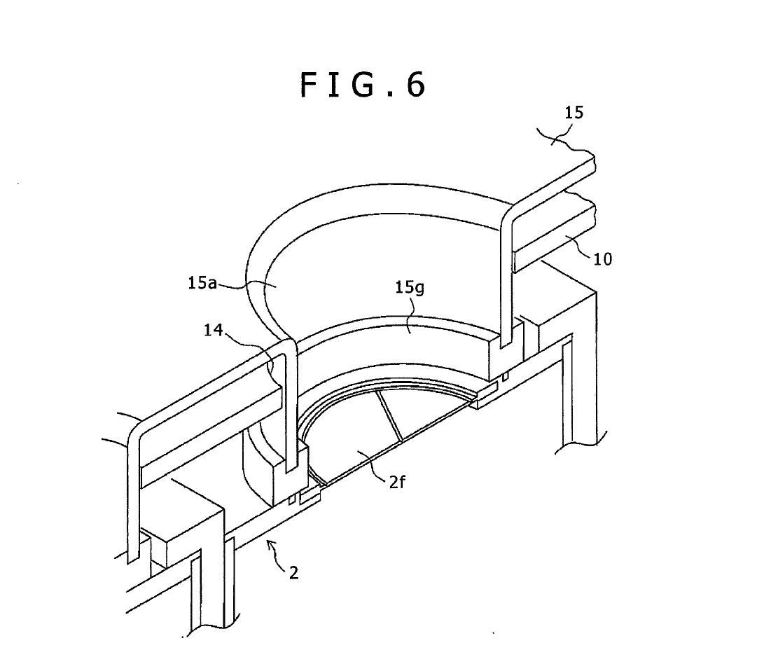

Each of the duct materials constituting the vent duct 15 includes the vertical pipe parts 15a, 15a . . . that communicate with the gas vent valves 2f of the battery cells 2. As shown in FIG. 6, each vertical pipe part extends through the relevant through-hole 14 in the printed circuit board 10, and a sealing material 15g for establishing communication between the vertical pipe part 15a and the gas vent valve 2f without gas leakage is interposed therebetween. This construction ensures leakage-free communication between the gas vent valve 2f of each battery cell 2 and the vertical pipe part 15a of the relevant duct material through the sealing material 15g. Additionally, since the four duct materials communicate with one another through hold metals 16 without gas leakage, the gas vent valves 2f of the battery cells are arranged together for each vent duct 15 of array A and each vent duct 15 of array B, and thus to communicate with the vent pipes 15f at the left ends of both vent ducts.

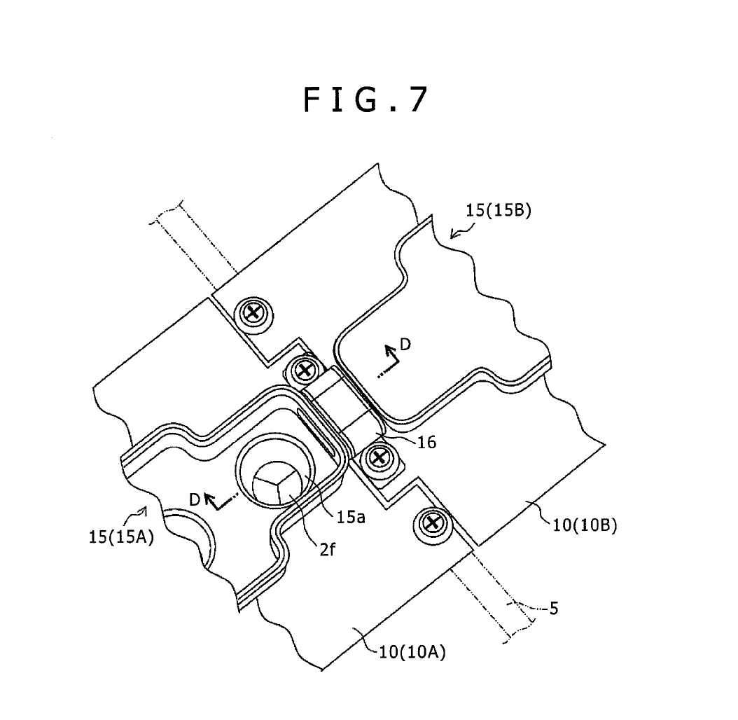

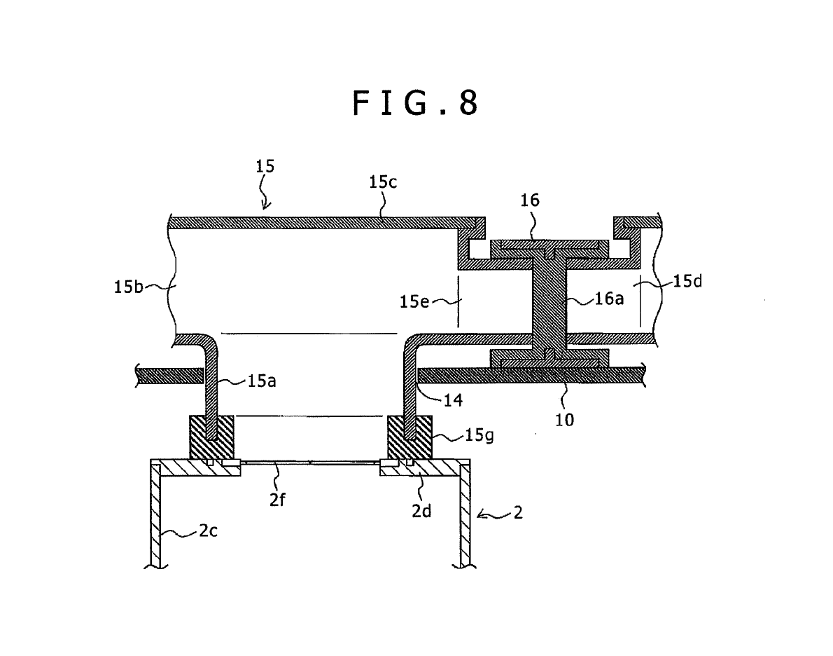

The communicating part for providing communication between internal spaces by connecting each divided duct material is, as shown in FIGS. 7 and 8, fixed to upper sections of the end plate 3 and section plate 5 via one hold metal 16. The hold metal 16, formed by metal diecasting or the like, is constructed so that the openings 15d, 15e that are the communicating parts of the duct materials are inserted into a central through-hole with a sealing material 16a interposed therebetween that is formed from soft rubber or the like. Thus, the duct materials are made to intercommunicate without gas leakage. The hold metal 16, formed with a through-holed foot, is fixed by bolting to an upper small pillar portion of a cylindrical shape of the relevant end plate 3 or section plate 5 through the through-hole in the foot. In this way, the duct materials of the vent duct 15 are connected at the respective communicating parts by the hold metals 16, 16 . . . , and after being fixed to the section plates 5 and the end plates 3, the duct materials are placed at the upper regions of each section in the battery block 1.

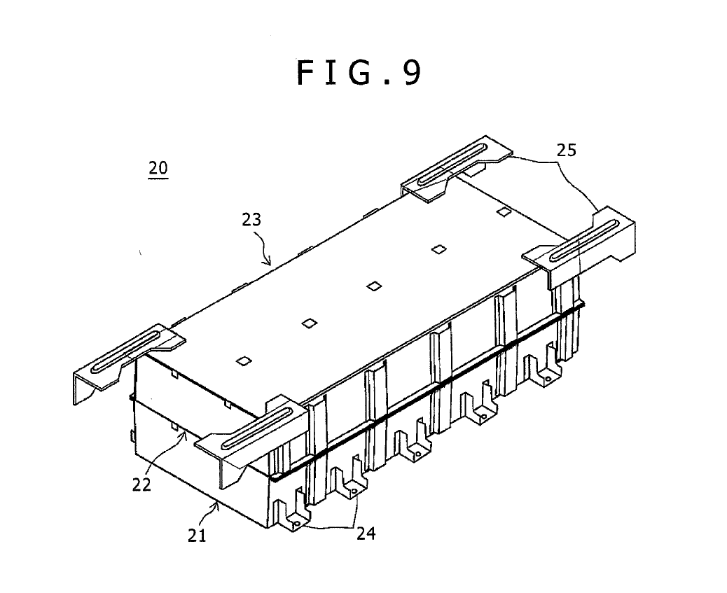

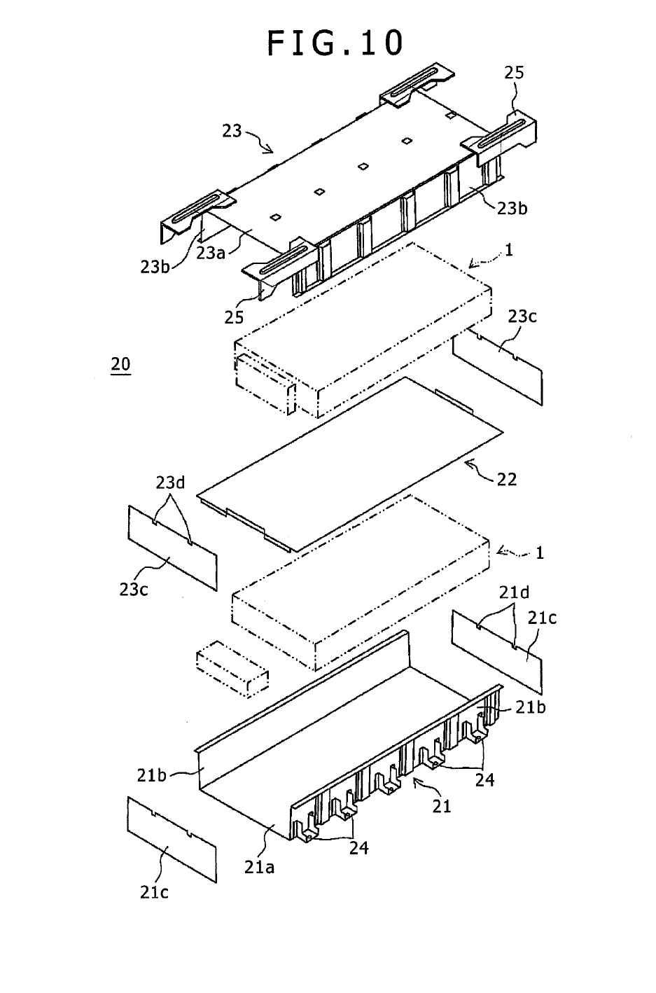

The thus-constructed battery block 1 is of a double-layer stacked structure as shown in FIGS. 9 and 10, and this structure is accommodated in a box to form a power supply device 20. The box is constituted by a lower case 21, an upper case 23, and a partition plate 22 positioned midway between the cases. In the power supply device 20, the battery block 1 with 48 battery cells 2 in the lower layer is housed in the lower case 21, the partition plate 22 intervenes between the battery block 1 of the lower layer and that of the upper layer, and the battery block 1 with 48 battery cells 2 in the upper layer is housed in the upper case 23. A flange at an outer edge of the lower case 21, an outer peripheral region of the partition plate 22, and a flange at an outer edge of the upper case 23 are bolted down together in a stacked condition, whereby the lower case, the partition plate, and the upper case are connected together and fixed to form the box for the power supply device 20.

The lower case 21, the partition plate 22, and the upper case 23 are each made of a metal that was formed by sheet-metal working, and strength of each is enhanced with a strengthening rib to enable accommodation of a heavy object. The lower case 21 is formed into a near-U sectional shape with lengthwise side portions 21b, 21b standing substantially upright from a central base 21a, and a near-U-shaped open space between the lengthwise side portions is blocked with side plates 21c, 21c. In this way, the lower case 21 is finally formed into a top-opened case-like shape having an accommodation capacity/volume appropriate for the battery block 1 of the lower layer. The partition plate 22 is worked by sheet-metal forming to have a flat plate shape with a strengthening rib so that the heavy battery block 1 can be supported, and the partition plate 22 is further formed into a shape so as to be able to block up the top-opened lower case 21 from above.

The upper case 23 is formed into an inverted near-U sectional shape with lengthwise side portions 23b, 23b hanging substantially straight downward from a central ceiling 23a, and an invertedly near-U-shaped open space between the lengthwise side portions is blocked with side plates 23c, 23c. In this way, the upper case 23 is finally formed into a downwardly opened case-like shape having an accommodation capacity/volume appropriate for the battery block 1 of the upper layer. The lower case 21 and the upper case 23 may each have a substantially top/bottom-inversed shape. Each side plate 21c is formed with notches 21d, 21d at its upper edge, each side plate 23c is also formed with notches 23d, 23d at its upper edge, and all these notches are formed to suit the positions of the vent pipes 15f connected to the left end of the vent duct 15.

The lower case 21, partition plate 22, and upper case 23 constituting the thus-constructed box for the power supply device 20 can be formed into a box of a double-layer (double-deck) structure by first stacking into three-layer form of the flange at the upper edge of the lower case 21 with the fixed side plates 21c, 21c, a flange at the outer edge of the partition plate 22, and the flange at the lower edge of the upper case 23 with the fixed side plates 23c, 23c, and then bolting down the outer peripheral regions of the three layers. After this, the battery block 1 of the lower layer is fixed to the base 21a in the space of the lower layer by means of locking bolts, and furthermore, the battery block 1 of the upper layer is fixed by means of locking bolts to an upper surface of the partition plate 22 that constitutes the base in the space of the upper layer. In this way, the power supply device 20 is constructed.

The lower case 21, partition plate 22, and upper case 23 constituting the box for the power supply device 20 are fixed to, for example, a vehicle body of an electric vehicle (not shown) that applies the power supply device. In this application, a plurality of lower support stays 24, 24 . . . protruding near the base of the lower case 21 are used to fix one section of the box to a floor surface of the vehicle body, and a plurality of upper support stays 25, 25 . . . protruding sideways from an upper surface of the upper case 23 are used to fix other sections of the box to other sections of the vehicle body.

Assembly of the above-constructed battery block 1 and power supply device 20 according to the present embodiment is described below. When the plurality of battery cells 2, 2 . . . are arrayed and then connected together and fixed to form the battery block 1, resin-made cell spacers 6 are first arranged near the end plate 3 at the front side in FIG. 2. Next, six battery holders 4 each with two battery cells 2 arrayed sideways are brought into contact with the cell spacers 4, then the first section plate 5 is set up in place, and six more battery holders 4, the second section plate 5, six additional battery holders 4, the third section plate 5, and six further battery holders 4 are arranged in that order. Finally, the end plate 3 at the rear side is set up in place. After this, five connecting rods 7 are inserted into through-holes from the end plate 3 at one side, and both ends of each connecting rod 7 are fixed by tightening the locking bolts not shown. This forms the battery cell group of the battery block 1 with 48 battery cells 2 integrated in arrayed form.

The thus-formed battery cell group of the battery block 1, despite the large number of arrayed, connected, and fixed battery cells 2, inhibits bending of an intermediate region of the long connecting rods and hence, movement of the battery holders 4 positioned midways in the battery cell group. The bending of the intermediate region is inhibited since the battery holders 4 each with two fixed battery cells 2 are separated into the four sections, S1-S4, by the midways intervening section plates 5, and thus since the connecting rods 7 are maintained at their fixed spatial intervals by the respective section plates 5. Consequently, a disturbance in arrayal is prevented and the battery block 1 improves in shape stability. That is to say, since each connecting rod 7, supported at both ends by the end plates 3, 3, and midways supported at its intermediate region by the three section plates 5, suppresses bending and other unwanted events, the connecting rod in the present embodiment, compared with a connecting rod supported only at both ends thereof, stabilizes the position of each battery holder 4 and causes no shift in the position of the battery holder 4.

After the 48 battery cells 2 have thus been integrated to form the battery cell group, each battery cell 2 is connected in series using the bus bars 8. Adjacent battery cells 2, 2 . . . can be connected in series by connecting the respective positive electrode outside terminals 2a and negative electrode outside terminals 2b to each other alternately via the short bus bars 8, 8 . . . since the terminals are located at alternate positions. In addition, connecting the outside terminal of the battery cell 2 supported by the battery holder 4 positioned at an end of array A, and the outside terminal of the battery cell 2 supported by the battery holder 4 positioned at an end of array B allows the 24 battery cells 2 in array A and the 24 battery cells 2 in array B to be connected in series, and hence the 48 battery cells 2 to be connected in series.

When the bus bars 8, 8A are to be fixed to the bolts on the outside terminals 2a, 2b, the connecting terminals 11, 11 . . . on the eight printed circuit boards, 10A to 10H, are inserted into through-holes of the terminal bolts and then tightened with nuts, whereby the bolts are fixed to a surface of the battery cell group in which the printed circuit boards, 10A to 10H are arranged and electrical continuity is established as well. The printed circuit boards 10A-10H are also fixed to upper sections of the end plates 3, 3 and those of the three section plates, 5, 5 . . . , using the locking bolts. Once the printed circuit boards 10A to 10H have been fixed, the six through-holes 14 formed centrally on the boards at equal intervals are positioned at upper sections of the gas vent valves 2f of the battery cells 2.

In this way, the printed circuit boards 10A to 10H are divided for each section, S1 to S4, of the battery block 1 and also fixed for each section, so the number of battery cells 2 in each section is easy to increase/reduce, which in turn facilitates changing of a desired voltage and/or the capacity of the battery block. In addition, on each printed circuit board 10A to 10H, six fuses 12 are fixed at positions corresponding to six battery cells 2, and these fuses blow in case of electrical interconnection trouble such as short-circuiting, so an abnormality of the battery block 1 can be rapidly sensed and appropriately processed as well.

After the fixing of the printed circuit boards 10A-10H, the vent duct 15 is placed thereupon. The sealing material 15g is disposed at an end of the vertical pipe parts 15a of the duct materials 15A to 15H, along the battery cells arranged in array A, and after the communicating part of the duct material 15A and that of the duct material 15B have been opposed to each other and the communicating parts of the duct materials 15A, 15B have been inserted by fitting in the sealing materials 16a under the hold metals 16, locking bolts are inserted into the through-holes formed in the feet of the hold metals 16 to fix the communicating parts to the upper sections of the end plates 3 and section plates 5 by means of locking bolts. Thus, the vertical pipe part 15a of each duct material with the sealing material 15g interposed at the end of the pipe part comes into firm contact with the gas vent valve 2f of the relevant battery cell 2 through the through-holes 14 in the relevant printed circuit board 10A to 10H. This sequence is repeated and the communicating parts of each duct material 15C, 15D are connected to each other and then fixed to the section plate 5 and the end plate 3 via the hold metals 16.

After this, the vent pipe 15f is connected to the opening in the communicating part at the left end of the first duct, 15A, to fix the vent pipe 15f using a hold metal 17, and the opening in the communicating part at the right end of the last duct, 15D, is blocked to complete the placement of the vent duct 15. In this way, the vent duct 15 is divided into the duct materials for each section of the battery block 1 and also fixed for each section, so the number of battery cells 2 in each section is easy to increase/reduce, which in turn facilitates the changing of the desired voltage and/or the capacity of the battery block. In the vent duct 15 of array B, four duct materials are likewise connected together and fixed to the end plates 3 and the section plates 5. In addition, since the vertical pipe parts 2a of the vent duct 15 extend through the through-holes 14 in the printed circuit board 10 and communicate with the gas vent valves 2f of the battery cells 2, even after the construction of the battery block 1 with the printed circuit board 10 and the vent duct 15 stacked at the upper region of the battery cell group in which the plurality of battery cells 2 are arrayed, height of the battery block 1 can be reduced and compact construction thereof can be attained.

The battery block 1 thus constructed by forming the battery cell group inclusive of the plurality of arrayed, connected, and fixed battery cells 2, installing the cooling air duct 9 on both sides of the battery cell group, mounting the printed circuit board 10 at an upper region of the battery cell group, and mounting the vent duct 15 at a further upper region thereof, is accommodated in the box for the power supply device 20. That is to say, the battery block 1 of the lower layer is rested on the base 21a of the lower case 21 constituting the box, and then the battery block 1 is fixed to the base 21a of the lower case 21 using the locking bolts and the feet 3a and 5a formed at the bases of the end plates 3, 3 and section plates 5, 5 . . . constituting the battery block 1. The battery block 1 is fixed to the lower case 21, at the feet 3a of the end plates 3, 3 positioned at both ends of the battery block 1, as well as at the feet 5a of the section plates 5, 5 . . . intervening midways between the large number of battery holders 4, so the fixed state of the battery block 1 stabilizes.

After the battery block 1 of the lower layer has been accommodated in the lower case 21 and fixed, the top-opened region of the lower case 21 is shrouded with the partition plate 22, the battery block 1 of the upper layer is rested at an upper region of the partition plate 22 under that state, and the battery block 1 of the lower layer is fixed to the intermediate partition plate 22 using the locking bolts and the feet 3a and 5a formed at the bases of the end plates 3, 3 and section plates 5, 5 . . . constituting the battery block 1. The battery block 1 of the upper layer is also fixed to the partition plate 22, at the feet 3a of the end plates 3, 3 positioned at both ends of the battery block 1, as well as at the feet 5a of the section plates 5, 5 . . . intervening midways between the large number of battery holders 4, so the fixed state of the battery block 1 of the upper layer stabilizes similarly.

After the above, the upper case 23 is mounted over the battery block 1 of the upper layer, the flange on the outer periphery of the lower case 21, the outer edge of the partition plate 22, and the flange at the outer periphery of the upper case 23 are stacked, and the three elements are connected together and fixed using the locking bolts not shown. Fixing the box with the locking bolts may be done by extending the bolts through the flanges or may use any other appropriate method. When the double-deck battery blocks 1, 1 are housed inside the lower case 21, the partition plate 22, and upper case 23 constituting the box, the vent pipe 15f of the vent duct 15 at which the gas vent valves 2f of the battery cells 2 constituting the battery block 1 fits to the notches 21d, 23d on the side plates 21c, 23c. Connecting vent hoses (not shown) to the vent pipes 15f through the notches, therefore, allows an exhaust gas to be released from the box of the power supply device 20.

In this way, the outer edge of the partition plate 22 present at the intermediate position between the lower case 21 and the upper case 23 is interposed between the flange on the outer periphery of the lower case 21 and the flange on the outer periphery of the upper case 23, and the three elements are bolted down together, such that the box of the power supply device 20 can be completed and hence the number of parts can be reduced. In addition, the number of working hours required for assembly can be reduced and weight reduced. Since the battery block 1 of the lower deck is fixed to the lower case 21 at the lower side and since the battery block 1 of the upper deck is fixed to the partition plate 22 present at the intermediate position, the fixed states of the battery blocks 1, 1 stabilize, which in turn helps reduce the number of parts required and thus reduce thickness of the power supply device in a height direction thereof. Furthermore, when the power supply device 20 is installed on the vehicle body of a vehicle or the like, since the lower support stays 24, 24 . . . of the lower case 21 immobilize a lower section of the box and the upper support stays 25, 25 . . . of the upper case 23 immobilize an upper section of the box, the immobilized state of the box stabilizes, which for example, prevents the power supply device 20 from becoming unstable during traveling of the vehicle, and leads to comfortable traveling.

While embodiments of the present invention have been described in detail above, the invention is not limited to the embodiments and may incorporate various changes in design without departing from the spirit of the invention that is described in the appended claims. For example, the above embodiments have been described in detail with a view to making the invention better understandable and are necessarily limited to a mode in which all of the described constituent elements are provided. In addition, part of the elements of an embodiment may be replaced by or added to the elements of another embodiment. Furthermore, part of the elements of an embodiment is subject to addition, deletion, or replacement in other embodiments.

Although lithium-ion secondary cells have been shown and described as an example of battery cells in the above embodiments, the kind of applicable battery cell is not limited to lithium-ion secondary cells and it goes without saying that these battery cells may be replaced by an array of nickel-hydrogen batteries or other batteries or of battery cells of a secondary battery.

### INDUSTRIAL APPLICABILITY

The present invention can be used in such applications as an electric motor vehicle or hybrid vehicle employing the battery block and/or power supply device of the invention. The invention can also be used in applications as railroad vehicles of hybrid specifications.

### DESCRIPTION OF REFERENCE SYMBOLS

1: Battery block, 2: Battery cell, 2a: Positive electrode outside terminal, 2b: Negative electrode outside terminal, 2c: Prismatic case, 2d: Battery cover, 2e: Filling port, 2f: Gas vent valve, 3: End plate (Section plate), 4: Battery holder, 5: Section plate, 6: Cell spacer, 7: Connecting rod, 8, 8A: Bus bars (Connecting bars), 10 (10A to 10H): Printed circuit board (Voltage sensing boards), 12: Fuse, 14: Through-hole, 15: Vent duct, 15A to 15H: Duct material, 15a: Vertical pipe part (part communicating with the gas vent valve), 16: Hold metal (Hold member), 20: Power supply device, 21: Lower case (Box), 22: Partition plate (Box), 23: Upper case (Box), 24: Lower support stay, 25: Upper support stay, S1 to S4: Sections

1-13. (canceled)

14. A battery block in which a plurality of battery cells are arrayed, connected, and fixed, wherein:
the battery cells are formed from a plurality of sections each including a predetermined number of battery cells separated as one section by a section plate;
the battery cells each include a gas vent valve;
a vent duct that establishes communication between the gas vent valves of the battery cells is provided in the battery block; and
the vent duct is formed by connecting duct materials previously divided for each section separated by the relevant section plate.

15. The battery block according to claim 14, sandwiched between two end plates, with the two end plates and the section plates both being bolted down and fixed via a plurality of rods extending through the end plates and the section plates, along a direction in which the battery cells are arrayed.

16. The battery block according to claim 14, wherein:
the battery cells are each accommodated in a hermetically enclosed prismatic case;
outside terminals and the gas vent valve are positioned on an upper surface of the prismatic case; and
the vent duct is disposed along the upper surface of the prismatic case.

17. The battery block according to claim 14, wherein the divided duct materials are each fixed to the relevant section plate via a hold member.

18. The battery block according to claim 14, further comprising a voltage sensing board that senses a voltage of the battery cells, wherein: the voltage sensing board is placed between the battery cells and the vent duct; and through-holes through which vertical pipe parts of the vent duct that communicate with the gas vent valves extend are formed on the voltage sensing board.

19. The battery block according to claim 18, wherein: the voltage sensing board is formed by connecting segments previously divided for each section separated by the relevant section plate.

20. The battery block according to claim 18, wherein the voltage sensing board includes a fuse.

21. The battery block according to claim 19, wherein the voltage sensing board is divided into continuous segments and fixed to the section plates.

22. A power supply device in which the battery block according to claim 14 is of an upper/lower double-layer structure, accommodated in a box, wherein:
the box includes a lower case, an upper case, and a partition plate present at a position intermediate between the lower case and the upper case; the battery block of the lower layer is accommodated in the lower case; the partition plate intervenes between the battery block of the lower layer and that of the upper layer; the battery block of the upper layer is accommodated in the upper case; and the lower case, the partition plate, and the upper case are connected together and fixed at an outer edge, an outer peripheral region, and an outer edge, respectively, thereof.

23. The power supply device according to claim 22, wherein the section plates each include a foot to fix the relevant battery cell and wherein the feet of the battery block of the lower layer are fixed to a base plate of the lower case and the feet of the battery block of the upper layer are fixed to the partition plate.

24. The power supply device according to claim 22, wherein the lower case includes a support stay and the upper case includes a support stay.
